(19) United States
(12) Patent Application Publication
(10) Pub. No.: US 2009/0026253 A1
(43) Pub. Date: Jan. 29, 2009

(54) Promotional and/or advertising device with automatically remotely identifiable sheet support, particularly for advertising and promotional purposes

(75) Inventor: Giovanni Pilla, Milano (IT)

Correspondence Address: PEARNE & GORDON LLP, 1801 EAST 9TH STREET, SUITE 1200, CLEVELAND, OH, 44114-3108, US

(73) Assignee: Riccardo Pilla, Milano (IT)

(21) Appl. No.: 11/659,142

(22) PCT Filed: Jun. 10, 2005
(86) PCT No.: PCT/IB2005/001631

§ 371 Date: Feb. 1, 2007

(30) Foreign Application Priority Data
Jun. 10, 2004 (IT) MI2004A001159

(51) Int. Cl. G06Q 30/00; G09F 23/00

(52) U.S. Cl. 235/375; 705/14; 40/299.01; 283/56

(57) ABSTRACT

It is provided an automatically remotely identifiable paper medium in particular for advertising or promotional purposes, having at least one passive unit (2) of a transponder (3) irremovably associated therewith, said unit being adapted to interact with an active read unit (4) of the transponder itself.

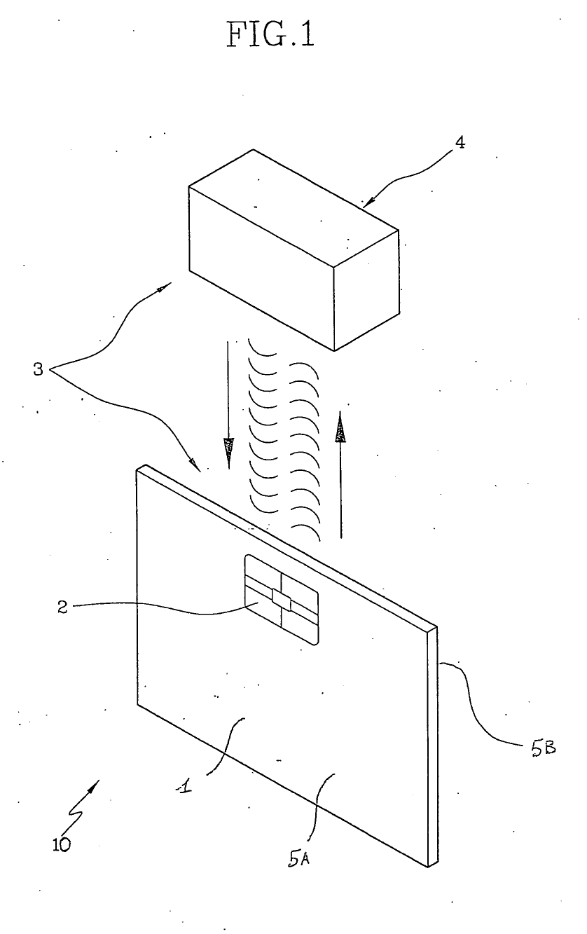

The present invention relates to a promotional and/or advertising device equipped with an automatically remotely identifiable sheet support or medium, made of paper material for example, in particular for advertising or promotional purposes.

It is known that a transponder is a device made up of an active read unit and at least one passive unit adapted to emit reply signals when requested by external pulses sent by the same active read unit in the form of radio waves, sound waves or others.

Each passive unit is identifiable by the read unit because the coded reply signals emitted therefrom contain specific information of their own that is different from that of another passive unit. Said information can be stored in a micro-memory disposed within a chip power supplied by suitable circuit elements, due to the effect induced by the radio-waves received by the passive unit through a micro-antenna and/or other.

In the case, instead, of an ultrasound transponder, said ultrasonic waves act on a component of the passive unit of the piezoelectric type capable of converting the mechanical energy of the incident sound vibrations into electric energy so as to reflect the received sound waves and suitably modify them to enable the same to be unequivocally identified.

Also known is use of paper materials such as leaflets, cards, picture postcards, brochures, maps or other types of media to transmit advertising or promotional messages generally directed to increase the sale of goods or advertise services, commercial and recreational activities and the like.

Sometimes on the above mentioned paper media, identification codes are reproduced that enable prize wins, discount obtaining, participation in competitions, free admittance to given places or allow other types of advantages or facilities to be obtained. In this case the reading procedure of the codes printed on the paper media, in addition to involving the necessity to use suitably assigned staff, also can give rise to many inconveniences and waste of time under some particular situations such as those where accidentally or intentionally the simultaneous presence of many persons in the same place occurs; all that may sometimes induce the owners of said paper media not to take advantage of the offers contained therein, thereby practically reducing the efficiency of the advertising or promotional messages.

In addition it will be recognised that currently known and widespread transponders are all substantially arranged so as to enable traceability and identification of a given product. In other words, it is presently known to use transponder systems with a passive unit associated with a given product so that the code present in the passive unit can allow a predetermined number of significant data relating to the product itself to be identified; for instance, production data, data concerning the producer firm, the distributor, etc.

Under this situation, the technical task underlying the present invention is to devise an automatically proximity identifiable support or medium for advertising and promotional purposes enabling the limits and drawbacks of traditional paper media of the type having identification codes allowing direct visual reading to be eliminated.

Within the scope of this technical task it is an important aim of the invention to conceive a promotional and/or advertising device provided with an automatically remotely identifiable sheet support or medium, in particular for advertising or promotional purposes, enabling recognition of the codes associated therewith to be facilitated thus avoiding inconveniences and waste of time and making the messages transmitted thereby more efficient and tempting.

It is a further aim of the invention to make available a transponder system of easy and simple implementation without requiring expensive procedures of identification and/or registration of the user and also without needing long procedures for data input as those required for tracing the products provided with the passive unit.

The technical task mentioned and the aims specified are substantially achieved by an automatically remotely identifiable sheet medium, in particular for advertising or promotional purposes, that is characterised in that it has at least one passive unit of a transponder associated therewith in an irremovable manner, which passive unit is adapted to interact with an active read unit of the same transponder.

The description of same preferred but not exclusive embodiments of an automatically remotely identifiable paper medium in accordance with the invention is now given by way of non-limiting example, with reference to the accompanying drawing in which:

the only FIGURE diagrammatically shows a paper support and an active read unit of the information retransmitted by the same medium, in a perspective view.

With reference to the drawing, the promotional and/or advertising device in accordance with the invention is generally identified by reference numeral 10.

The device 10 first of all comprises a support or medium 1 preferably of sheet material such as paper, plastic, imitation leather, leather or other, so that the production costs can be very reduced and the same is adapted to be personalised through printing or the like.

To this aim the paper medium 1 has two opposite faces 5a, 5b on at least one of which messages and/or graphic representations of promotional or advertising nature are printed.

According to an alternative solution (or in combination with the above mentioned prints) information for the user can be present such as maps or road maps or also promotion of cultural activities of different nature. These supports therefore can be in the form of leaflets, cards, invitations, tickets, brochures, maps, postcards or similar products.

Obviously the paper medium can reproduce indications about the fact that the same will enable prizes to be won, professional information to be given or still others, due to the passive chip contained in the leaflet itself.

Medium 1 will generally be of personal use and in particular designed to be carried and used by a single owner. In other words medium 1 will generally be intended for private use and designed to a single person and will not be of public use as it can be the use of a shopping trolley in a supermarket, a store, or the like.

As an alternative embodiment use of an artefact such as a gadget, a puppet, a key ring or case or the like can be provided, that will perform the functions of the above described medium.

At all events medium 1 will be adapted for transportation by the owner without giving rise to bulkiness or trouble problems, as it can be stowed in a pocket or a wallet.

In an original manner a passive unit 2 of a transponder 3 of the conventional type and known by itself is irremovably associated with the sheet material 1, which transponder also comprises an active read unit 4.

The passive unit 2 will be secured by means of adhesive material or glue onto the paper medium surface or it can be incorporated or concealed thereinto depending on requirements.

In a first embodiment the transponder 3 is a transceiver in which the passive unit 2 is adapted to receive pulses transmitted from the active read unit 3 and to retransmit coded reply signals, in the form of radio waves.

In this first embodiment the passive unit 2 comprises suitable and known micro-components such as an antenna, a chip, a memory, circuit elements among which at least one condenser to store the electric energy produced by induction by the electromagnetic waves striking thereon and sent by the active read unit 4.

In a second embodiment, also known and still more advantageous from an economic point of view as compared with the first embodiment due to the very low price at which it is available on the market, the transponder 3 is a transceiver in which the pulses transmitted from the active read unit and the coded reply signals retransmitted by the passive unit 1 consist of high-frequency sound waves.

In this second embodiment, the passive unit 2 comprises specific and known micro-components among which at least one piezoelectric element and suitable surfaces adapted to reflect the incident sound waves and to modify them so that they can be unequivocally identified.

It will be also recognised that the code contained in the passive unit 2 will not enable identification of the medium's owner.

It is also important to point out that the code contained in the passive unit 2 is not an identification code of the medium and/or the passive unit itself. In other words, reading of the code will not enable the history to be traced or historical information to be obtained as regards the medium containing it.

The promotional and/or advertising device can be provided, in addition to the mentioned transponder system, with a processing unit capable of inputting the code read by the passive unit 2 and comparing it with a plurality of stored codes to establish a correspondence therewith and generate a corresponding output.

The output can be of any nature, of the sound or light type, or can even be in a data format.

For instance and not in a limiting manner, a code correspondence can involve winning of a prize, a discount or a free admittance to a place, or also a promotional action in general; alternatively, the code will activate a promotional function in a computer, TV or radio or other apparatus that will deliver data and news in relation either to a geographic resort or to a cultural, sports or society event.

By way of example, the device in accordance with the invention can be used as a video wall; tickets, cards or gadgets are distributed and a display stand and/or a circuit created in a given place cause the persons travelling over the circuit to activate films, sounds, scents, smells, etc.; possibly the card may also operate a mechanical mechanism such as a mannequin for promotional-advertising purposes.

The invention can also be used in a shop in which a screen installed therein close to or attached to the shop window can be operated by a passer-by in possession of the medium, which passer-by may also be out of the shop itself moving the card in a given position and therefore making a video, an audio or a mechanical mechanism start.

The system can also be implemented on credit cards or automatic teller machines, as upon payment a terminal provided with an audio and/or a video will be able to supply information on payment, collecting data and/or the status of the fidelity program combined with the card and also a message of advertising nature.

Obviously the above can also apply to all types of fidelity or membership cards such as those of airlines, railway and shipping companies, hotels, petrol companies, etc.

The invention can also be implemented in cards, brochures, tourist leaflets, booklets combined with a person, bracelets or rings.

The above, when delivered to an individual, give an opportunity to the latter to use screens, TV and radio sets, etc. distributed in a given place (a town, museum, station, information point, for example) in order to obtain information on services, works of art, shows, and are also able to transmit advertising information.

Obviously, uses in several different languages can be provided, i.e. a foreign tourist will have a medium adapted to make information, news and advertising matter start in his/her language.

Also a skipass, upon passage for use of the ski-lifts, chair-lifts, etc. will be able to start an advertising message on a screen/TV and also a plurality of information on the condition of the ski runs, on temperature, snow, etc.

The media, in addition to starting promotional or advertising messages on a screen will also be able to activate a mechanical advertising form.

For instance in a museum the medium provided with the passive unit will be able to start mechanical mechanisms indicating the path to be followed, etc.

The medium containing the passive unit will be also adapted for use in order to purchase a given service via the Internet. Upon the purchase, the central system will associate the code contained in the passive unit with the purchased service (a ticked for the cinema, for example). When the user presents himself/herself to the cinema, a screen or the like will transmit an advertising message in addition to enabling access to the cinema hall.

As a further applicative example, said media can be also used for prepaid cards; during use for shopping, in addition to money being balanced down, a video can give information on the residual value, the amount spent and promotional or advertising information on different goods.

Should the patented system be implemented on devices such as motorway cards for toll payment, during the operations for payment a voice would give information on the traffic, the weather, etc. and could also deliver messages of promotional/advertising nature.

Obviously, the same operation could be obtained with tickets for trains, ships or airlines.

Use of the present system in cards with mechanisms capable of emitting scents could be also very advantageous. In particular it would be possible to have an advertising card of a given brand that on interaction with the active unit will emit the corresponding scent.

The system is also advantageous in cards for holiday villages that on use of same will cause starting, on a screen, of information on a possible residual credit or on the features of the purchased goods or service, as well as starting of promotional actions or advertising messages and of information on the scores of possible competitions, lotteries or others.

The invention also offers particular advantages in the game field. The results of a lottery or a “scratch and win” game can be in audio or video format.

In addition all invitation cards to particular events, conferences, meetings, conventions, discotheques provided with this system will enable an interactive entrance combined with advertising and promotional actions, scores and information.

Finally, the cards will be able to operate machines capable of offering a product or a service for advertising, promotional of fidelisation purposes.

For example, with the supermarket card, close to an automatic citrus-fruit squeezer it will be possible to operate the system and offer a fruit juice free of charge to the consumer that, at the same time, will be able to see the characteristics of the product, prices, possible promotional and advertising information, on a video.

The same information could be printed in an automatic manner.

The invention achieves important advantages.

In fact, first of all, the paper medium in accordance with the invention enables a quick and easy identification of the codes associated therewith because reading of said codes takes place automatically and under proximity conditions practically without engaging staff, except for control functions as regards correct operation of the recognition procedure and the obtained results.

In addition, the paper medium in accordance with the invention, due to its feature of minimising possible inconveniences connected with identification of said medium, can efficiently help in positively modifying the behaviour of the individuals coming into possession of it and therefore in conclusion in improving the advertising or promotional efficiency of the paper medium itself.

Finally, it will be recognised that the addition of an automatic identification system to known paper media for commercial uses only increases the production cost of same to a quite negligible degree.

1-12. (canceled)

13. A promotional device comprising:
a medium (1) for personal use, made of sheet material such as paper, plastic, imitation leather, said medium of sheet material having representations of promotional-advertising nature on at least one of the faces (5a, 5b) thereof;
at least one passive unit (2) containing a code;
at least one active read unit (3) capable of interacting with the passive unit (2) under proximity conditions to receive at least said code, following an interrogation;
a memory associated with the active read unit (3) which contains a predetermined number of main codes;
a processing unit capable of inputting said code read on the passive unit (2) by the active read unit (3) and comparing the code with at least said predetermined number of main codes to determine a correspondence therewith;
the processing unit carrying out visual signs associated with the read code.

14. A device as claimed in claim 13, wherein the medium (1) for personal use made of sheet material is a ticket, a picture postcard, a leaflet or a card.

15. A device as claimed in claim 13, wherein the medium (1) for personal use is made of paper material.

16. A device as claimed in claim 13, wherein the visual signs are of advertising or promotional nature.

17. A device as claimed in claim 13, wherein the medium (1) is designed to be carried and used by a single owner; the passive unit containing no identification data of said single owner.

18. A device as claimed in claim 17, wherein the medium (1) is designed to be carried by a single owner and to be used by the same single owner or eliminated.

19. A device as claimed in claim 13, wherein said passive unit (2) is part of a transponder system, receives pulses transmitted by the active read unit (4) and retransmits coded reply signals in the form of radio waves.

20. A device as claimed in claim 13, wherein said passive unit (2) is part of a transponder system, receives pulses transmitted by the active read unit (4) and retransmits coded reply signals in the form of sound waves.

21. A device as claimed in claim 13, wherein said code contained in the passive unit (2) is not an identification code of the medium and of the passive unit.

22. A device as claimed in claim 13, wherein said representations of promotional-advertising nature indicate the presence in the medium of said passive unit (2) designed to interact under proximity conditions with the active read unit (3) placed in a remote position.

23. A device as claimed claim 13, wherein the medium (1) is for private use and not for public use.

24. An advertising device comprising:
a medium (1) for personal use made of sheet material such as paper, plastic, imitation leather, said medium of sheet material having representations of promotional-advertising nature on at least one of the faces (5a, 5b) thereof;
at least one passive unit (2) containing a code, said code being not a code for identification of a medium owner;
at least one active read unit (3) interacting with the passive unit (2) under proximity conditions to receive at least said code, following an interrogation;
a memory associated with the active read unit (3) which contains a predetermined number of main codes;
a processing unit capable of inputting said code read on the passive unit (2) by the active read unit (3) and comparing the code with at least said predetermined number of main codes to determine a correspondence therewith;
the processing unit carrying out visual signs associated with the code read.
